(19) United States
(12) Patent Application Publication
(10) Pub. No.: US 2009/0109575 A1
(43) Pub. Date: Apr. 30, 2009

(54) Magnetic latch assembly

(76) Inventor: Matthew William McCoy-Deedler, Livonia, MI (US)

Correspondence Address: John G. Chupa;Law Offices of John Chupa and Associates, P.C., Suite 50, 28535 Orchard Lake Rd, Farmington Hills, MI, 48334, US

(21) Appl. No.: 11/977,397

(22) Filed: Oct. 24, 2007

(51) Int. Cl. G11B 5/54

(52) U.S. Cl. 360/256.2

(57) ABSTRACT

A magnetic latch assembly 10 which is selectively deployed on a cabinet door or drawer 102 and which normally causes a latching portion 40, which includes a permanent magnet 32, to be in a latching or locked position. A magnetic key 200 provided in the vicinity of the magnet 32 causes the latching portion 40 to decouple from an engaged position to a disengaged position, and which automatically returns the latching portion 40 to an engagement position when magnetic key 200 is removed from the vicinity of the magnet 32.

### FIELD OF THE INVENTION

The present invention generally relates to the field of locking devices, and more particularly, to a novel magnetic latch assembly that may be selectively and operatively deployed in cabinets, chests, or other selectively lockable enclosures for selectively locking and unlocking doors of these tangible entities. The present invention also provides a method for effectively, securely, and selectively latching enclosures.

### BACKGROUND OF THE INVENTION

Magnetic latches are widely used and are selectively attached to doors, container lids, cabinets and such other selectively closed entities to secure these entities in a in a locked and/or unlocked position. Particularly, these magnetic latches are typically deployed on desks, drawers, or any other tangible entity that a user desires to selectively latch, and generally comprise a latching member, for selectively engaging a surface of a tangible entity, and one or more permanent magnets or an electrically energizable member that functions as a magnet, and which cooperates with the latching member to selectively lock/unlock the tangible entity. Further, these magnetic latches provide locking and unlocking functionality without requiring the use of a conventional lock and key assembly to latch the entity and thereby obviating the need to store and identify which keys to use with a particular conventional lock.

While such magnetic latch assemblies do provide a way to selectively lock and unlock doors, cabinets and other similar types of entities, such assemblies suffer from drawbacks.

By way of example and without limitation, some magnetic latch assemblies utilize permanent magnets to provide a biasing magnetic force to pivot or slide a latching member into a locking slot in order to “normally” cause the latching member to be in a “locked state”, absent the presence of a magnetic force or some other countervailing force. The term “normal” means that this biasing force, in the absence of any other counteracting or countervailing force, causes the assembly to be locked. While this type of arrangement does allow an assembly to be “normally” locked, foreign objects and dust, which are often times present in industrial environments, can and do oftentimes prevent the latch from pivoting back into latching by being resident within the locking slot, thereby preventing the relatively weak biasing magnetic force from forcing the latching member to move against such resident foreign objects.

Further, in many of these assemblies, a repulsive magnetic force is utilized to provide a biasing type latching force on the magnetic latch. While such a non-physical” biasing or latching force may indeed latch the assembly into a normally “closed” or “locked” state, it may be interrupted by or interfaced with by environmental conditions (such as in an environment with much electro-magnetic interference) and such interruption may not only weaken the signal strength but also actually destroy the signal, thereby causing the assembly to fail to latch or lock. Thus, while a user may think that the latch is locked, in reality the latch and the associated enclosure are really in an unlocked position.

Yet further, other magnetic latch assemblies require a user to take some “positive action” on a biasing portion of the latch assembly (e.g., by means of lifting a latching member with a forefinger) to manually position the latching member into a latching and locked position, and thus do not provide an automatic biasing force on the latching member. In these magnetic latch assemblies, the magnetic latch assembly, once unlocked, does not automatically return the locking member to a latching position and requires a user to physically lift a latching member and apply biasing force to place the biasing portion in a latching position. This increases the complexity of the magnetic latch while requiring user interaction every time a door is selectively locked.

Further, many magnetic latch assemblies require the drilling or forming of a large-diameter bore into a door or cabinet in order to accommodate the latch assembly in an operative position, and thus require a relatively complicated installation to selectively and securely position the magnetic latch assembly in a desired manner. Such a complex requirement is undesirable as it not only involves the time-intensive step of physically drilling a large-diameter bore to secure a magnetic latch assembly to a door of a cabinet or chest but also increases the complexity of installation.

Yet further, other magnetic latches, which utilize electricity to selectively energize a magnetic latch to accomplish the latching function, require a complicated structure in addition to having many parts, which makes the latch more complex and expensive to sell and manufacture, while at the same time requiring that an electrical source be located within close proximity of the electrical latch to power the magnetic latch, which further limits the locations where these magnetic latches can be installed. Furthermore, in the event of a power failure, a majority of these assemblies fail to maintain their locked position. Other latches require many moving parts, and therefore make the magnetic latch more expensive to manufacture and sell.

The present invention overcomes these and other disadvantages and drawbacks of prior and currently utilized magnetic latch assemblies in a new and novel manner, which is more fully delineated below.

### SUMMARY OF THE INVENTION

It is a first non-limiting object of the present invention to provide a magnetic latch, which includes a novel magnetic latch assembly, which overcomes some of the previously delineated drawbacks of prior and existing magnetic latches.

It is a second non-limiting object of the present invention to provide a magnetic latch assembly which allows for a cabinet or other tangible entity to be selectively locked and unlocked in a desired manner and which overcomes some of the previously delineated drawbacks of prior and existing magnetic latches and latch assemblies.

It is a third non-limiting object of the present invention to provide a magnetic latch assembly which provides a “positive and physical biasing force” to securely keep the magnetic latch assembly in a normal and latched position, and which overcomes some or all of the drawbacks of prior magnetic latch assemblies, such as by way of example and without limitation those which are set forth above.

It is a fourth non-limiting object of the present invention to provide a magnetic latch assembly, which automatically returns to a latched condition after an attractive magnetic force is removed.

It is a fifth non-limiting object of the present invention to provide a method for using a magnetic latch assembly in which a drawer, desk, or other tangible entity may be placed in a latched condition.

According to a first non-limiting aspect of the present invention, a magnetic latch assembly is provided and includes a slot and which is selectively attached to a movable door, and which is selectively movable from a first closed position to a second open position; a first portion which includes a biasing portion which physically couples said first portion to said mount and which causes said first portion to normally reside within said slot, effective to cause said door to be prevented from moving from said first closed position to said second open position, where said first portion further including a magnet; and a handheld magnetic key which, when brought in close proximity to said magnet, causes said first portion to be forcibly removed from said slot, effective to allow said door to be selectively moved from said first closed position to said second open position.

According to a second non-limiting aspect of the present invention, a magnetic latch assembly is provided and includes a “L-shaped” mount comprising a first planar portion and a second planar portion, which is orthogonal to first planar portion and includes a slot, wherein first planar portion and second planar portion form an interior reception space in which a stop portion resides; a latch member having a third planar portion which is substantially similar to second planar portion of mount, and a fourth planar portion which is orthogonal to third planar portion, and which includes a tab, which resides in the slot of first planar portion, and a guide which projects from end of fourth planar portion and to form an acute angle, and a fifth planar portion which extends from attachment point of third planar portion and fourth planar portion and in a substantially same plane as third planar portion of latch member, and a magnet disposed at the end of fifth planar portion and located opposite the guide of fourth planar portion, and a band which binds latch member against mount at second planar portion and third planar portion, the magnetic latch assembly which returns to a locked or latched condition when a magnetic key is removed from the vicinity of the magnet, thereby removing a user to manually position the magnetic latch assembly in a locked or latched position.

According to a third non-limiting aspect of the present invention, a first mount is provided which is “moldably” formed to contain a first planar portion, a second planar portion which is orthogonal to first planar portion, a slot formed within second planar portion, and a stop which resides in the cavity formed between first planar portion and second planar portion; a second latch member is provided which is moldably formed to contain third planar portion, a fourth planar portion orthogonal to third planar portion and which contains a tab formed within the cavity of third planar portion and fourth planar portion, and a fifth planar portion which is substantially straight and along the same plane as fourth planar portion; and a permanent magnet at end of second latch member which is directly opposite to a guide located at other end of second latch member, and a biasing portion to physically connect first mount to second latch member, the magnetic latch assembly which comprises relatively few parts and is thus relatively inexpensive to manufacture.

According to a fourth non-limiting aspect of the present invention, a method for selectively latching a cabinet is provided comprising the steps of providing a cabinet with a door; fixedly securing a magnetic latch assembly upon an inside surface of the door; closing the door and causing the magnetic latch assembly to securely and selectively latch the cabinet.

According to a fifth non-limiting aspect of the present invention, a method for selectively latching a toilet is provided comprising the steps of providing a toilet with a lid; fixedly securing a magnetic latch assembly upon an inside surface of the lid; closing the lid and causing the magnetic latch assembly to securely and selectively latch the toilet.

These and other features, aspects, and advantages of the present invention will become apparent to those of ordinary skill in the art from a reading of the following detailed description of the preferred embodiment of the invention, including the subjoined claims, and by reference to the following drawings.

### BRIEF DESCRIPTION OF THE DRAWINGS

FIG. 1 is a side view of a magnetic latch assembly that is made in accordance with the teachings of the preferred embodiment of the invention and is shown being operatively deployed on a cabinet drawer in a resting and latched condition.

FIG. 2 is a side view of magnetic latch assembly which is shown in FIG. 1, and which is shown as being operatively placed in an “unlocked” condition.

FIG. 3 is a side view of the magnetic latch assembly, which is shown in FIGS. 1-2 and being shown with the drawer being selectively closed.

FIG. 4 is a side view of the magnetic latch assembly which is shown in FIGS. 1-3, but which is shown engaging the drawer edge when an opening force is applied to the drawer.

FIG. 5 is a side view of a magnetic latch assembly which is made in accordance with the teachings of an alternate embodiment of the invention.

FIG. 6 is an exploded unassembled view of the magnetic latch assembly shown in FIGS. 1-4.

FIG. 7 is a perspective view of the assembled magnetic latch assembly which is made in accordance with the teachings of the preferred embodiment of the invention and which is shown in FIGS. 1-4.

FIG. 8 is an exploded unassembled view of a magnetic latch assembly which is made in accordance with the teachings of yet another alternate embodiment of the invention.

FIG. 9 is a side view of a magnetic latch assembly which is shown in FIG. 8 and which is shown being operatively deployed on a cabinet drawer in a resting and latched condition.

FIG. 10 is a side view of a magnetic latch assembly which is made in accordance with the teachings of yet another alternate embodiment of the invention and is shown being operatively deployed on a cabinet drawer in a resting and latched condition.

FIG. 11 is a exploded unassembled view of a magnetic latch assembly which is made in accordance with the teachings of yet another alternate embodiment of the invention.

FIG. 12 is a side view of a magnetic latch assembly which is shown in FIG. 11 and which is shown as being operatively deployed on a cabinet in a resting and latched condition.

FIG. 13 is a side view of a magnetic latch assembly which is shown in FIG. 7 and which is shown as being operatively deployed on a toilet lid in a resting and latched condition.

FIG. 14 is an exploded side view of a magnetic latch assembly which is shown in FIG. 13 and which is shown engaging the toilet edge when an opening force is applied to the toilet lid.

FIG. 15 is a side view of a magnetic latch assembly which is made in accordance with the teachings of yet another alternate embodiment of the invention.

FIG. 16 is an exploded side view of a magnetic latch assembly which is shown in FIG. 15.

### DETAILED DESCRIPTION OF THE PREFERRED EMBODIMENT OF THE INVENTION

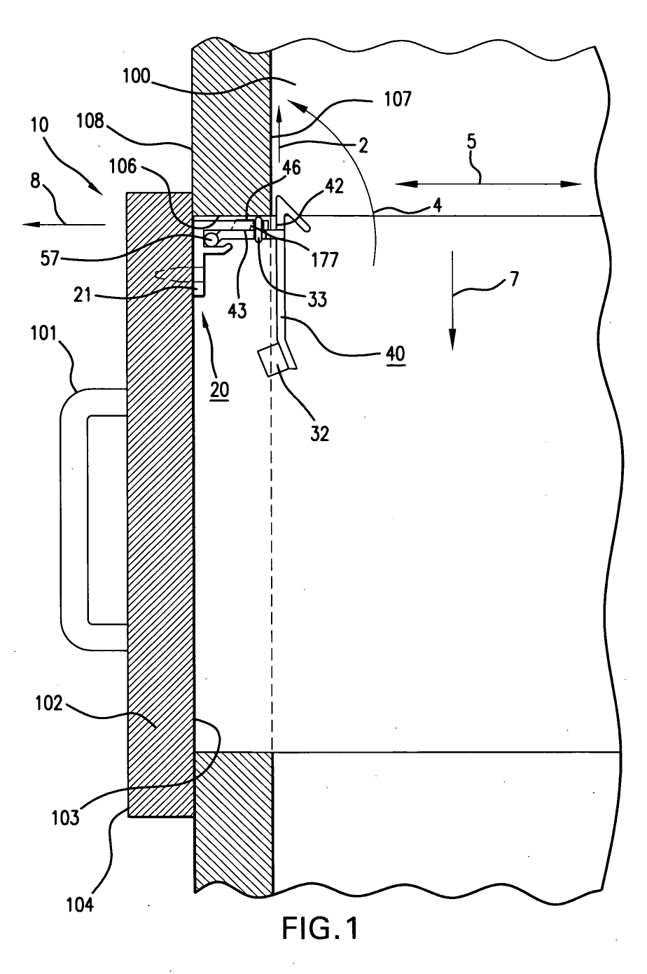

Referring now to FIG. 1, there is shown a magnetic latch assembly 10, which is made in accordance with the teachings of the preferred embodiment of the invention. It should be appreciated that the terms “magnetic latch assembly” and “magnetic latch” may be interchangeably utilized throughout this description and are each used to describe a magnetic latch assembly, such as magnetic latch assembly 10, which is adapted to be attached to a drawer 102 or other tangible entity which is a selectively movable portion of, as a non-limiting example, an article of furniture as shown (e.g., drawer 102 may be disposed in a cabinet or other article of manufacture). Latch assembly 10 may be operatively deployed upon any other entity, which is selectively movable from a first closed position to a second open position.

Particularly, the magnetic latch assembly 10 is shown securely attached to a drawer 102 of cabinet or other tangible entity 100 at inner surface 103, and this attachment can be made by a screw, glue, or other methods, while the cabinet or tangible entity facia 104 (i.e., the surface of the cabinet door 102 opposite to surface 103 and that which is traditionally viewed by a user of the cabinet 100) provides the attachment surface for a cabinet handle 101. The magnetic latch assembly 10, as disclosed herein, is easily adapted to be attached to any number of articles of furniture or other types of tangible entities, such as but not limited to dressers, cabinets (such as illustrated in FIG. 1), containers, and the magnetic latch assembly which is depicted within the various drawings are done so for illustrative purposes only. In essence, the assembly 10 may be selectively and operatively deployed upon any tangible entity having a portion which is selectively movable from a first closed position to a second open position and which is selectively movable from the second open position to the first closed position. Particularly, the assembly 10 may allow the selectively movable portion to be locked or selectively unlocked in the manner described later in this description.

Referring now to FIGS. 1, 6, and 7, magnetic latch assembly 10, in the preferred although non-limiting embodiment of the invention comprises a generally “L-shaped” mount 20. Particularly, mount 20 has a first planar portion 21, and a second planar portion 22 which orthogonally and integrally terminates into and generally and orthogonally emanates from the first planar portion 21. First planar portion 21 and second planar portion 22 cooperatively form a pocket 23 in which raised stop portion 24 resides.

That is, raised stop portion 24 integrally terminates onto portion 21, is linearly coextensive to width 300 of portion 21, and orthogonally protrudes from portion 21 into the pocket 23 and includes a substantially flat ledge 29 having an end 64 which forms an angle 301 with the flat portion of the ledge 29. In one non-limiting embodiment, angle 301 may be obtuse. Furthermore, a pair of substantially similar holes 26, 27 are formed within the planar portion 21 to fixedly attach mount 20 on inside surface 103 of cabinet door 102 (i.e., by the use of screws, bolts, or other types of fasteners which respectively and selectively traverse holes 26, 27 and are received into surface 103). It is important to note that holes 26, 27 could be substantially any shape or size and that additional fastening holes (not shown) may be formed within the portion 21. Furthermore, mount 20 includes a slot 25 formed on planar portion 22, and slot 25 has flat edges 171, 173 and tapered or beveled edges 170, 172 with each edge 170, 172 having a substantially similar and certain slope or taper 251. In an alternate yet non-limiting embodiment, edge 170 may have no slope. Mount 20 also includes substantially identical “V-shaped” grooves 28, 30 formed in planar portion 22. It is important to note that in one non-limiting embodiment, additional grooves, of various and dissimilar shapes, may be formed within planar portion 22. Additionally, it should be appreciated that in the most preferred embodiment of the invention, holes 26, 27 are relatively small and therefore obviate the need for a relatively large bore to be created in the inside surface 103.

Magnetic latch assembly 10, as previously delineated, also comprises a latch member 40. Particularly latch or latch member 40 has a substantially “L-shaped” portion 41. Portion 41 has a first abutment member 42 and member 40 includes a second planar portion 43 that orthogonally protrudes from and integrally terminates into abutment member 42 and also integrally terminates into and integrally includes a cylindrical end 57 which is linearly coextensive to width 307 of planar member 43. Furthermore, latch member 40 further includes a guide member or portion 44 which extends from and integrally terminates onto end 45 of abutment member 42 while forming an acute angle 111 with abutment member 42, thereby cooperating with member 42 to form a substantially “V-shaped” trough or cavity 5. Planar portion 41 of latch member 40 also includes a raised tab portion 46 which is formed on surface 47 of second planar member 43 and which extends away from surface 47 in direction 1.

Furthermore, in one non-limiting embodiment, tab 46 has flat edges 175, 176, and tapered or beveled edges 174, 177 with edges 174, 177 each having substantially the same slope or taper 178. In an alternate yet non-limiting embodiment, edge 174 is flat or planar. Tab 46, in one non-limiting embodiment, has a thickness 150 which is at least the thickness 160 of planar portion 22 of mount 20. Finally, planar member 43 also includes substantially identical “V-shaped” grooves 48, 50, and which, in one non-limiting embodiment, are substantially identical to “V-shaped” grooves 28, 30 of planar portion 22, although, in one non-limiting embodiment, other substantially identical “V-shaped” grooves may be formed and which align with additional grooves in planar portion 22.

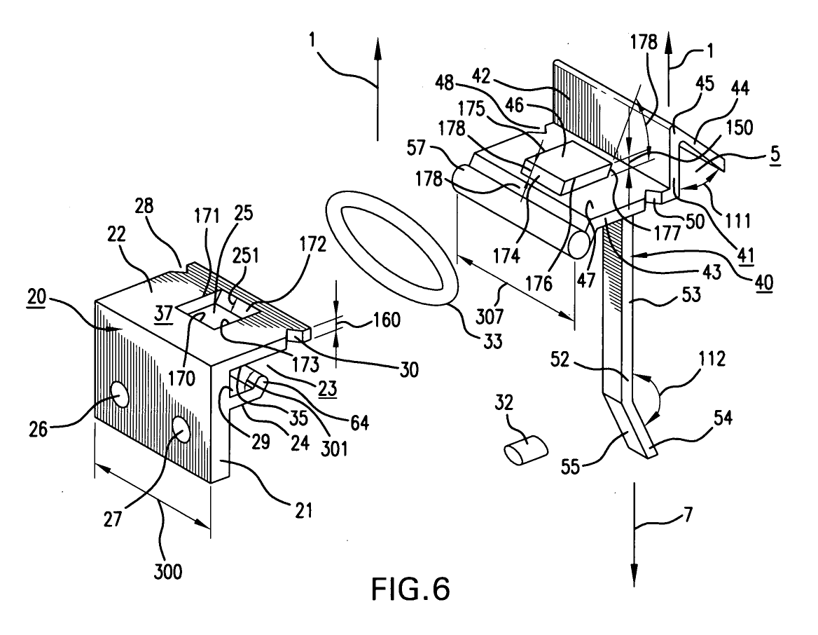

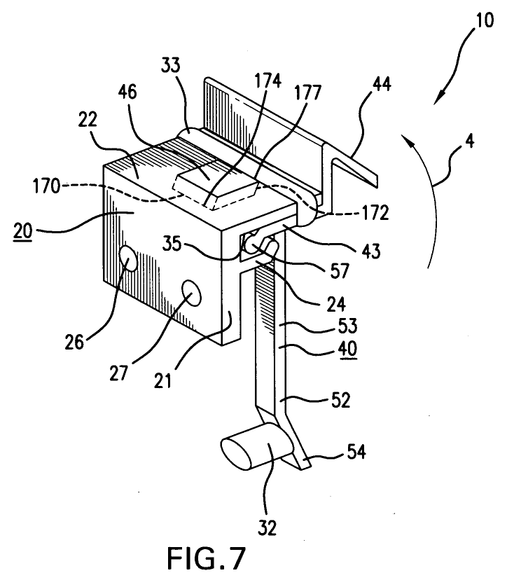

Additionally as shown in FIGS. 6 and 7, latch 40 also includes a generally “L-shaped” member or portion 52, which integrally and orthogonally terminates into the portion 43 and which extends away from planar portion 43 in direction 7 (i.e., in a direction opposite of direction 1). Member 52 includes a top portion 53 and an end portion 54, which forms an obtuse angle 112 with top portion 53. Additionally, latch 40 includes a permanent magnet 32, which is attached to end portion 54 on surface 55, and this attachment could be made by the use of a pin, glue, or other connection or fastener type entities or methods. Lastly, latch assembly 10 includes a selectively compressible band 33, which is adapted to be selectively attached to and removably and respectively received within grooves 28, 30 of portion 22 and grooves 48, 50 of portion 43. In one non-limiting embodiment of the invention, band 33 comprises at least one elastic band.

In a normal and “resting” condition, as shown in FIGS. 1, 6, and 7, latch member 40 is coupled to mount 20 by selectively and slidably placing end 57 of planar portion 43 into pocket 23, and rotating latch member 40 counter-clockwise along arc 4 (as best seen in FIG. 7) until beveled edge 174 of tab 46 contacts beveled edge 170 of slot 25 and beveled edge 177 of tab 46 contacts beveled edge 172 of slot 25 such that tab 46 wholly resides within and is received by slot 25 and “rises above” (e.g., in a direction away from magnet 32) planar portion 22. Furthermore, the at least one elastic band 33 is placed across portion 41 and portion 22 such that band 33 resides within grooves 28, 30 of portion 22, and grooves 48, 50 of planar portion 43. The “stretching force” of band 33 cooperatively and physically forces latch member 40 against mount 20 while cylindrical end 57 is restrained by edge 64 thereby ensuring that end 57 continues to reside within pocket 23 (i.e., on portion 24), and tab 46 continues to reside within slot 25.

Therefore, in this normal position, latch 40 and mount 20 are physically connected by elastic band 33 with tab 46 being received within and emanating from the slot 25. Band 33 applies a “positive biasing force” against planar portions 22 and 43 (e.g., this “positive biasing force” comprises the elastic force caused by stretching the band 33), and therefore keeps surface 47 in physical contact with bottom surface 35 of portion 20, thereby keeping tab 46 attached and wholly residing within slot 25, and thus keeps magnetic latch assembly 10 in a locked position in which the door 102 is prevented from being substantially moved in the direction 8 since abutment portion 42 contacts cabinet edge 107 (i.e., portion 21 is placed upon the surface 103 such that portion 42 hits or abuts edge 101 when drawer 102 is closed. The term “closed”, in this context, means that drawer 102 is 102 is moved in a direction opposite to direction 8 as far as it can before it contacts edge 107. The term “open”, in this context, means a movement of drawer 102 in direction 8, away from contact with edge 107). Notably, the positive force provided by band 33 is not affected by electromagnetic interference, which can cause a magnetic latch to fail, and which oftentimes is present in industrial environments and do oftentimes prevent other magnetic latches from pivoting back into latching and locked position due to the relatively weak biasing magnetic force.

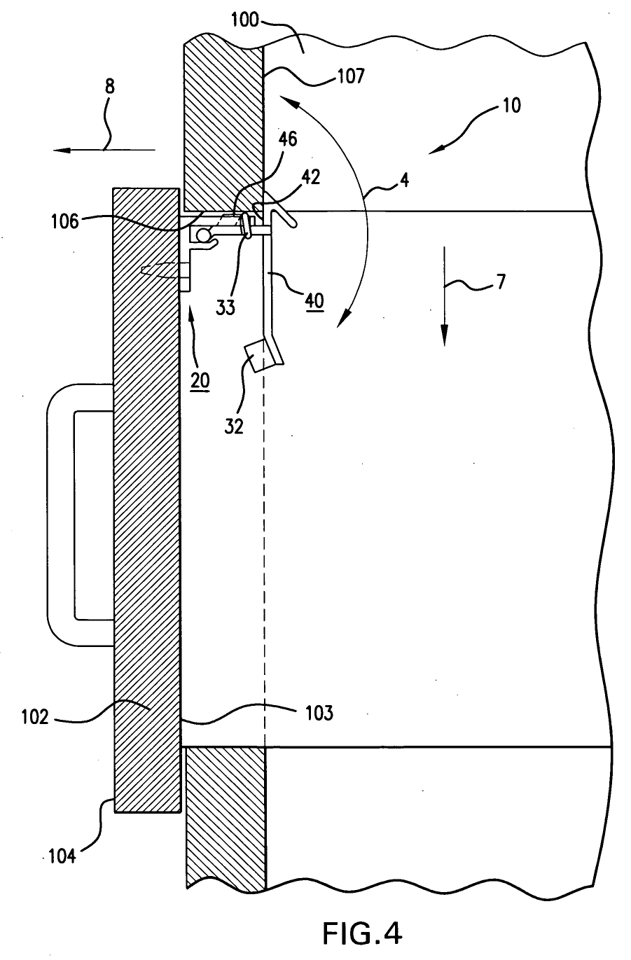

Now, also as seen in FIG. 1, magnetic latch assembly 10 is attached to cabinet door 102 (i.e., mount 20 is attached to the surface 104), and this attachment could be made by screws, bolts, or glue or other fastener members which may traverse holes 26, 27. In this normal position, abutment 42 of latch 40 extends vertically beyond cabinet edge 106 along direction 2. When an opening force (such as that by a hand of a user) is applied against drawer 102 in the direction 8, as shown in FIG. 4, magnetic latch assembly 10 is restrained by cabinet edge 107 due to the engagement of edge 107 with abutment member 42. As abutment member 42 contacts drawer edge 107, beveled edge 177 of tab 46 engages beveled edge 172 of slot 25 and this engagement prevents latch 40 from further travel along direction 7. Moreover, band 33 provides a cooperative compressive force on latch member 40 against mount 20 to ensure that tab 46 continues to reside in slot 25 when force is removed on drawer 102, thereby preventing latch 40 from rotating clockwise along an arcuate direction opposite to direction 4 and dislodging tab 46 from slot 25.

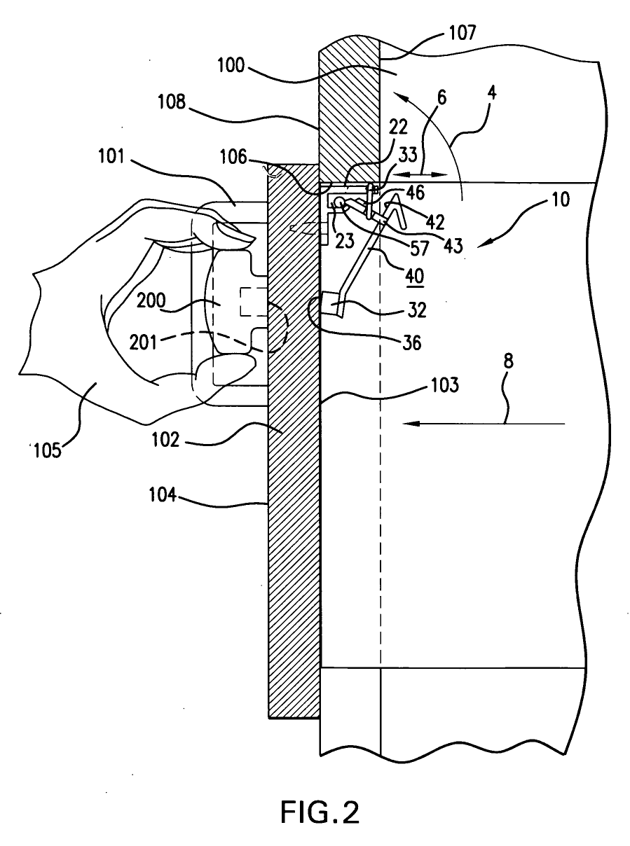

To unlock the cabinet 100, as best shown in FIG. 2, a magnetic key 200 in the form of a permanent magnet mounted in a handle for gripping by the user's hand 105, and which has its exposed pole 201 of the opposite magnetic polarity as exposed pole 36 of permanent magnet 32, is brought proximate to the vicinity of the cabinet door 102. The permanent magnet 32 is magnetically attracted to magnetic key 200 in the direction 8 due to a strong magnetic force between magnetic key 200 and magnet 32 and this magnetic attraction force rotatably pivots latch 40 clockwise in a direction opposite arc 4 until abutment 42 is withdrawn away from contact with the edge 107. In this “pivoted” or “unlocked” condition, tab 46 is withdrawn from slot 25 along a direction opposite of arc 4 due to the rotation of latch 40 and causes tab 46 to now reside below planar portion 22. Latch 40, which pivots or rotates upon portion 29 at end 57, continues to rotate in a direction opposite to arc 4 until magnet 32 touches inner surface 103 of drawer door 102, while band 33 stretches along grooves 28, 30 of portion 22 and grooves 48, 50 of portion 43.

The magnetic attraction between the key 200 and permanent magnet 32 is sufficient to enable the key 200 to remain adhered to or to engage the cabinet door 102 as the cabinet door 102 is opened using handle 101. Furthermore, the magnetic latch assembly 10 remains in this “opened” condition so long as magnetic key 200 applies a positive attractive force along direction 8 on magnet 32. When the magnetic key 200 is removed from the vicinity of the permanent magnet 32, band 33 applies a compressive “biasing” force on member 43 and member 22, which in turn pivots portion 42 back into contact with mount 20 (i.e., by causing portion 57 to move in a direction of arc 4), thereby returning tab 46 back into slot 25 and into a locking and latching condition (see FIG. 1). Thus, band 33 cooperatively provides a positive latching or (e.g., tab 46 is received within and emanates from or traverses slot 25).

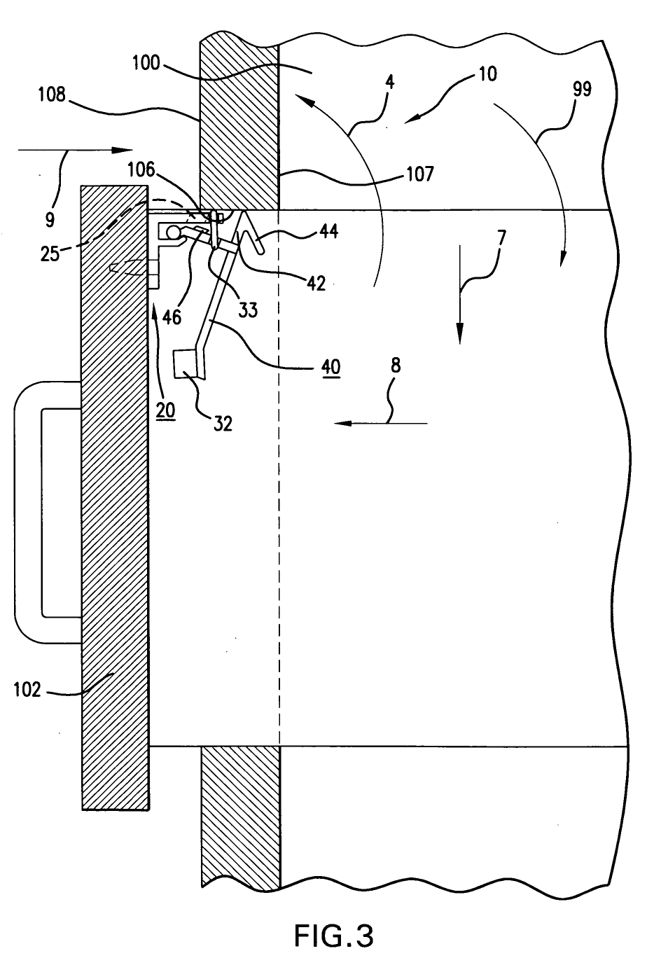

FIG. 3 shows the cabinet door 102 being physically and selectively closed from a selectively and physically open position by a force being applied on cabinet door 102 in direction 9. When the door 102 begins to close in the direction 9, guide 44 engages cabinet edge 108 and this engagement causes the guide 44 to rotate in a clockwise manner along arc 99. As the door 102 continues to close, the guide 44 engages cabinet edge 106 and this arcuate clockwise movement of the guide 44 causes the tab 46 to be removed from the slot 25 and causes the at least one band 33 to stretch. Finally, due to the continued movement of the door 102 in the direction 9, the guide 44 will come into a “disengaged relationship” with edge 106. When this occurs, band 33 cooperatively causes the tab 46 to be placed back into the slot 25, thereby causing the latch assembly 10 to be in a “locked state” (i.e., portion 42 rotates in direction 4).

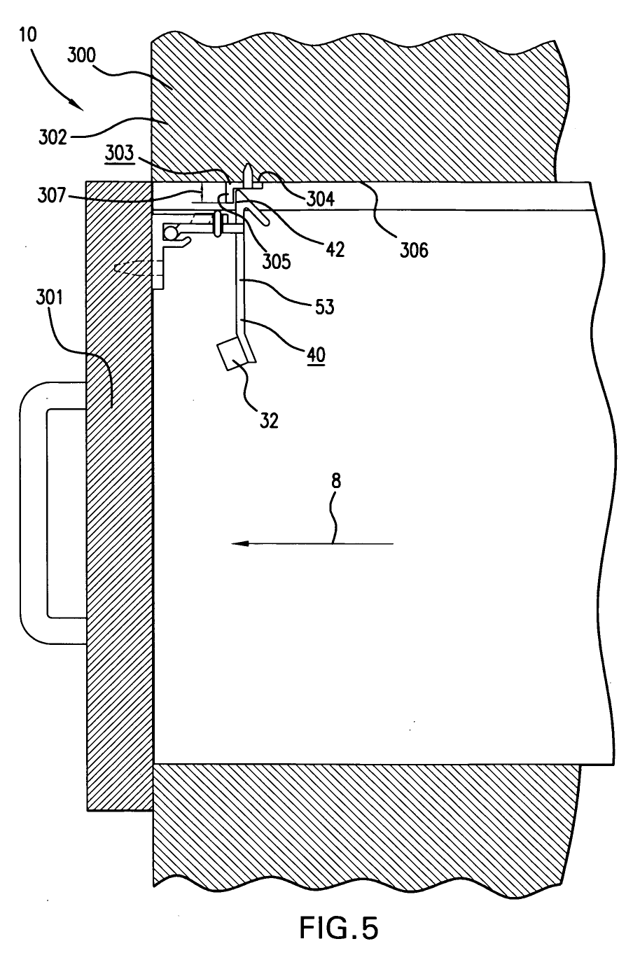

In some circumstances, and as shown in FIG. 5, a drawer, such as drawer 301, is deployed within a cabinet 300 or another sort of tangible entity of a type which does not provide the previously described edges 106, 108. That is, this type of cabinet or tangible entity, such as cabinet 300, is made to selectively receive a strike member 303 at the portion 302 of the surface 306 of the cabinet 300 which engages the portion 42 when the drawer 301 is physically placed in a closed position, and which may, in this non-limiting embodiment, be supplied with and as part of the latching assembly 10 and may be attached to the surface 306 by glue or other types of fasteners.

Particularly, strike member 303 has a first planar portion 304, and a second planar portion 305, which orthogonally and integrally terminates into and emanates from the first planar portion 304. Portion 304 of the strike member 303 is operatively and selectively attached to inside surface 306 of cabinet 300 such that portion 305 is generally parallel to portion 53 and is adapted to engage portion 42 so as to prevent the drawer 301 from being opened when the drawer 301 is moved in the direction 8. Only when the magnet 200 causes the previously described rotation of latch member 40, will portion 42 cease to engage the portion 305 of the strike member 303, thereby allowing the drawer 301 to be opened in the direction 8. It should be further appreciated that the strike member 303 can be manufactured from metal or molded plastic and can be adapted based on any particular drawer or any other selectively movable tangible entity. The length 307 of portion 305 may vary but this length should be sufficiently long such that the engagement of portion 305 with portion 42 will no cause tab to be completely or appreciably dislodged from slot 25.

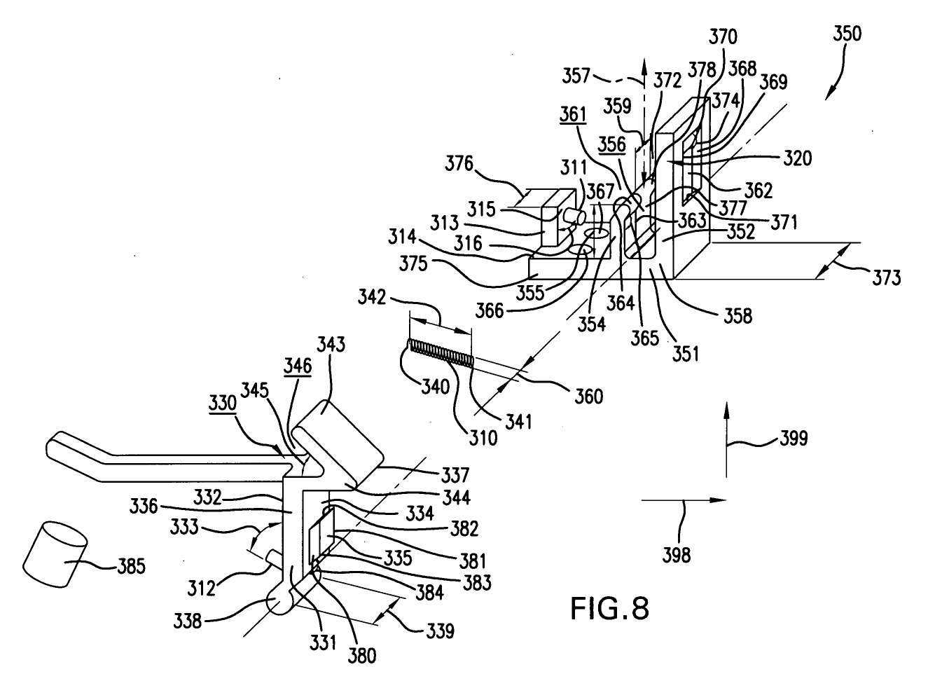

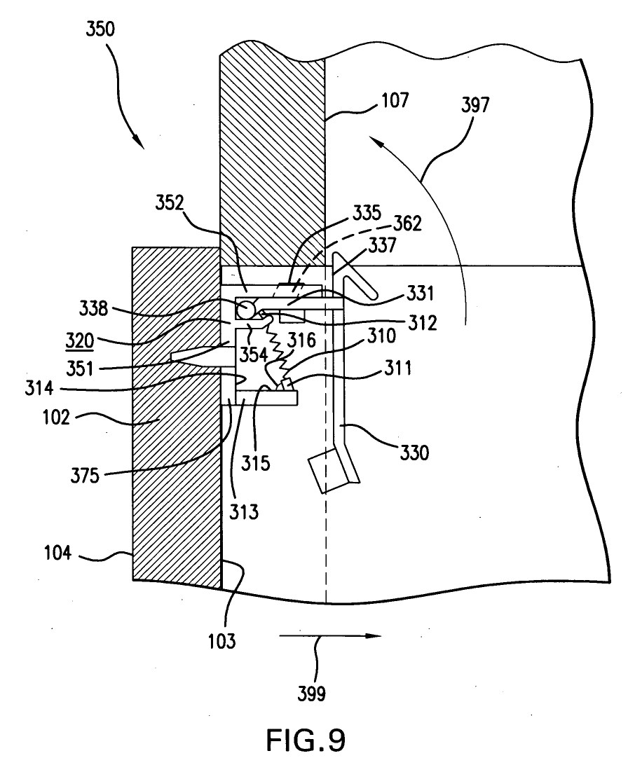

Yet, in another non-limiting embodiment, as best shown in FIGS. 8 and 9, magnetic latch assembly 350, comprises a generally “L-shaped” mount 320 which has a first planar portion 351 and a second planar portion 352 which orthogonally and integrally terminates into and emanates from first planar portion 351. First planar portion 351 and second planar portion 352 cooperatively form a pocket 361 in which a plurality of substantially similar raised stops 354, 372 reside with each having a height 355.

Raised stops 354, 372 integrally terminate onto planar portion 351 of mount 320, and orthogonally protrude from portion 351 into pocket 361, as was previously described for raised stop 24 in the preferred embodiment. Raised stop 354 includes a substantially flat ledge or body portion 363 and an end 364 which forms an angle 365 with the flat portion of the ledge, while raised stop 372 has a substantially similar flat ledge 377 and an end 378 which forms an angle 379 with the flat portion of the ledge 377, and in one non-limiting embodiment, angles 365, 379 may be the same and may be obtuse. End portions 364, 378 may be respectively “rounded” in another alternate embodiment. Raised stops 354, 372 are symmetrically located about axis 357 and are separated, thereby cooperatively forming a groove 356 which extends from surface 314 of planar portion 351 to end 363 in direction 399. Further, groove 356 has a width 359 which has a width that is larger than width 360 of spring 310 and in one non-limiting embodiment, groove 356 has a substantially constant width 359.

Furthermore, a pair of substantially similar holes 366, 367 are formed within the planar portion 351 to fixedly attach mount 320 on inside surface 103 of cabinet door 102 (i.e. by the use of screws, bolts, or other types of fasteners which respectively and selectively traverse holes 366, 367 and are received into surface 103). Furthermore, mount 320 includes a slot 362 formed on planar portion 352, and slot 362 has flat edges 368, 369 and tapered or beveled edges 370, 371 having a substantially similar and certain slope or taper 374. In an alternate yet non-limiting embodiment, edge 371 may have no slope.

Mount 320 also includes a rectangular shoe member 313 which orthogonally emanates and integrally terminates at end 375 of planar portion 351 (i.e., shoe member 313 extends from surface 314 in direction 399). Shoe member 313 has a width 376 which, in one non-limiting embodiment, is smaller than width 373 of mount 320. Also, shoe member 313 has a first cylindrical spring catch member 311 which emanates from surface 315 of shoe member 313 and which forms an acute angle 316 with surface 315 of mount 313.

Magnetic latch assembly 350 also comprises a latch member 330. Particularly, latch member 330 has a substantially or generally “L-shaped” portion 336. Portion 336 has a first abutment member 337 and member 330 includes a second planar portion 331 that orthogonally protrudes from and integrally terminates into abutment member 337 and also integrally terminates into and integrally includes a cylindrical end 338 which is linearly coextensive to width 339 of planar portion 331. Furthermore, latch member 330 further includes a guide member or portion 343 which extends from and integrally terminates onto end 344 of abutment member 337 while forming an acute angle 345 with abutment member 337, thereby cooperating with member 337 to form a substantially “V-shaped” trough or cavity 346. Planar portion 344 of latch member 330 also includes a raised tab portion 335 which is formed on surface 334 of second planar member 331 and which extends away from surface 334 in direction 398.

Furthermore, in one non-limiting embodiment, tab 335 has flat edges 380, 381 and tapered or beveled edges 382, 383 with edges 382, 383 each having substantially the same slope or taper 384. In an alternate yet non-limiting embodiment, edge 383 is flat or planar. Finally, latch member 330 includes a substantially similar second spring catch member 312 which is formed in planar portion 331. Particularly, spring catch member 312 is substantially similar in size and shape to spring catch member 311, and member 312 protrudes from and integrally terminates into planar portion 331 at surface 332 and forms an acute angle 333 with surface 332 of planar portion 331. Also, magnetic latch assembly 350 includes a single coiled spring 310 which has a length 342 from first end 340 and an opposed and second end 341, and in one non-limiting embodiment, any commercially available coiled spring may be utilized.

In a normal and “resting” condition, as shown in FIG. 9, latch member 330 is coupled to mount 320 by selectively and slidably placing end 338 of planar portion 331 into pocket 361, and coupling first end 340 of spring 310 onto spring catch member 311 of mount 320 and also coupling second end of spring 310 onto spring catch member 312 of latch member 330, and rotating latch member 330 counter clockwise along arc 397 until beveled edge 382 of tab 335 contacts beveled edge 370 of slot 362 and beveled edge 383 of tab 335 contacts beveled edge 371 of slot 362 such that tab 335 wholly resides within and is received by slot 362 and “rises above” (e.g., in a direction away from magnet 385) planar portion 352. It should be appreciated that in this normal and “resting” condition, the width 359 of groove 356 is sufficiently greater than the width 360 of spring 310 and causes the spring to reside within groove 356 when spring 310 is operatively mounted on spring catch members 311, 312 and thereby prevents spring 310 from making physical contact with tabs 354, 372 which may interfere with “normal” operation the magnetic latch assembly 350. The “compressive” biasing force of spring 310 cooperatively and physically forces latch member 330 against mount 320 while cylindrical end 338 is restrained by edge 363 thereby ensuring that end 338 continues to reside within pocket 361 and tab 335 continues to reside within slot 362.

Therefore, in this normal position, latch 330 and mount 320 are physically connected by spring 310 with tab 335 being received within and emanating from slot 362. Spring 310 applies a “positive biasing force” against planar portions 352 and 331 (e.g., this “positive biasing force” comprises the repulsive force exerted by compressing the spring 310), and thereby keeping tab 335 attached and wholly residing within slot 362, and thus keeps magnetic latch assembly 350 is a locked position in which the door 102 is prevented from being substantially moved in a direction opposite to direction 399 since abutment portion 337 contacts cabinet edge 107 as was previously described in the preferred embodiment. Spring 310 also provides a compressive “biasing” force on latch portion 331 and planar portion 352 to return tab 335 into slot 362 after tab 335 has been withdrawn from slot 362 during an unlatching operation. Thus, the spring 310 functions as band 33 in FIGS. 1, 6, and 7 and the operation of assembly 350 is similar to the previously explained operation of magnetic latch assembly 10.

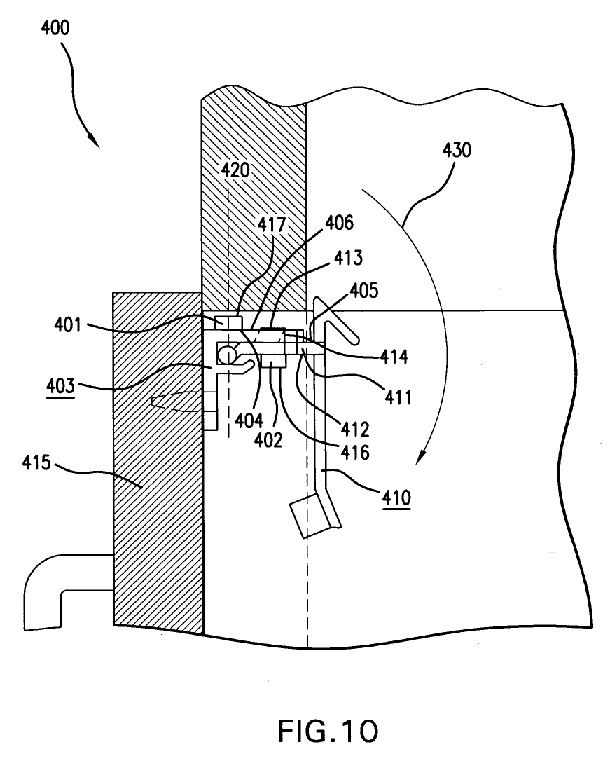

In another non-limiting embodiment, as best shown in FIG. 10, band 33 of magnetic latch assembly 10 is replaced with a pair of substantially identical permanent magnets 401, 402 while all other aspects of the magnetic latch assembly 400 remain the same as previously described magnetic latch assembly 10.

Particularly, magnetic latch assembly 400 includes a first magnet 401 and a second magnet 402, which is identical to first magnet 401. First magnet 401 is attached to planar surface 406 of planar portion 404 of mount 403 and opposite to surface of contact of planar portion 404 with latch member 411. Additionally, second magnet 402 is attached to planar portion 411 of latch member 410 and is offset from the vertical axis of symmetry 420 of magnet 401 and is attached to surface 412 which is opposite to surface of contact of planar portion 411 with planar portion 404 and whose exposed pole 416 is of the opposite polarity as exposed pole 417 of magnet 401.

Latch assembly 400 operates in substantially the same way as previously described latch assembly 10 of the preferred embodiment with magnets 401 and 402 providing a cooperative and magnetic “biasing force” on latch member 410 against mount 403 to ensure that tab 413 continues to reside in slot 414 in the normal “resting” position and thereby preventing latch member 410 from rotating clockwise along arcuate direction 430 and dislodging tab 413 from slot 414, while also providing the same cooperative and compressive force to return tab 413 into slot 414 after the tab 413 has been withdrawn from slot 414 during opening of drawer 415 upon applying magnetic key 300 or closing of drawer 415 from an open position. Magnets 401, 402 may be any commercially available magnets of any strength and size as long the magnets chosen provide a sufficient “positive biasing force” on latch member 410 and mount 403 to perform the aforementioned physical contact.

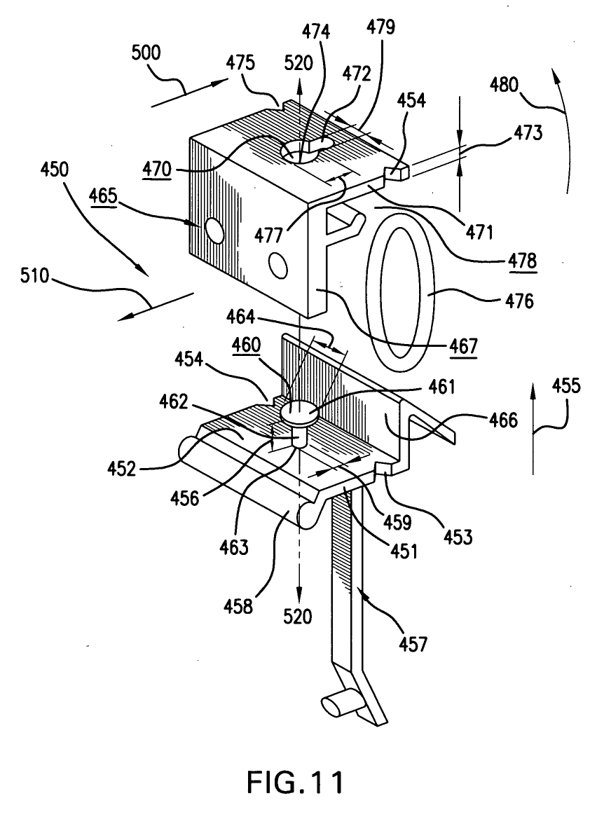

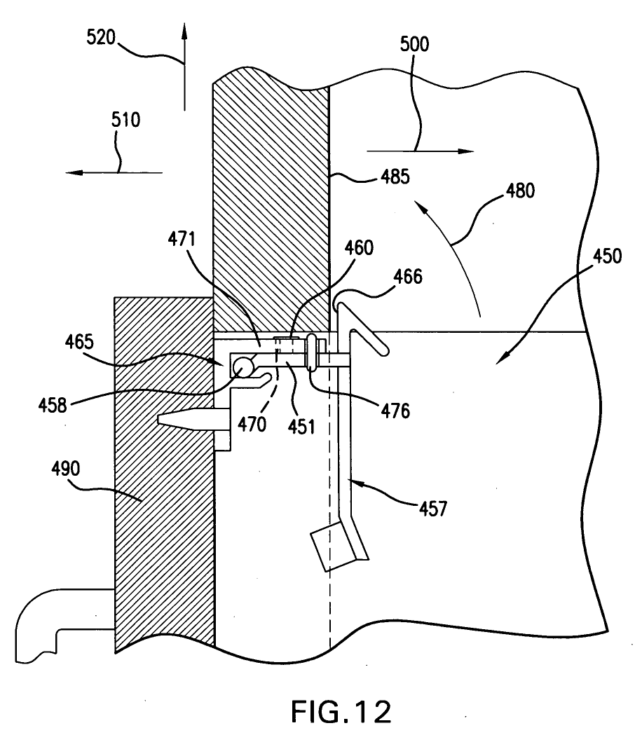

In yet another alternate, although non-limiting, embodiment as is best perhaps shown in FIGS. 11-12, tab 46 and slot 25 of magnetic latch assembly 10 may be replaced with a “knob” tab 460, and a “key hole” slot 470 while all other aspects of the magnetic latch assembly 450 remain the same as magnetic latch assembly 10 of the preferred embodiment.

Particularly, magnetic latch assembly 450 has a “knob” tab 460 attached to planar surface 452 of “L-shaped” planar portion 451 which was described in a preferred embodiment and which is referenced by numeral 40 in FIGS. 1, 6, and 7, and this attachment could be made by screws, bolts, or glue. Further, knob tab 460 has a first elongated and cylindrical portion 462 that orthogonally emanates from surface 452 in direction 455, and which terminates into a second “bulbous” or circular end or portion 461. “Bulbous” portion 461 is “disc” shaped and, in one non-limiting embodiment, has a width 464. In one non-limiting embodiment, elongated portion 462 has a length 456 that is at least the thickness 473 of planar portion 471 of mount 475 and a width 459 that is at least the width 479 of elongated portion 462 of slot 470. Further, “knob” tab 460 is aligned along vertical axis 520 (i.e., axis 520 passes through center of “knob” tab 460 in direction 455 and the center of surface 452).

Yet further, magnetic latch assembly 450 has a mount 465 which comprises a “key hole” slot 470 which replaces slot 25 of the preferred embodiment and which was previously described in FIGS. 1,6,7. Particularly, “key hole” slot 470 is formed on planar portion 471 of mount 465 and comprises a first substantially “circular” hole 474 and having a diameter 477, and which terminates into a second elongated hole 472 in direction 500 and having a width 479. Moreover, circular hole 474 is aligned along vertical axis 520 (i.e., axis 520 passes through center of circular hole 474 in direction 455 and through the center of surface 473). In one non-limiting embodiment, circular hole has a diameter 477 which is at least as large as width 464 of bulbous portion 461 of knob tab 460. Lastly, magnetic latch assembly 450 includes a selectively compressible band 476, which is adapted to be selectively attached to and removably and respectively received within grooves 453, 454 of planar portion 451 and grooves 454, 475 of portion 471, and which was described in a preferred embodiment. Also, in one non-limiting embodiment of the invention, band 476 comprises at least one elastic band.

In a normal and “resting” condition, as shown in FIGS. 11 and 12, latch member 457 is selectively coupled to mount 465 by selectively and slidably placing end 458 into pocket 478, and rotating latch member 457 counter-clockwise along arc 480 (as best seen in FIG. 12) until circular portion 461 “slides” through circular hole 474 and wholly resides within and is received within slot 470 and “rises above” planar portion 471. Furthermore, the at least one elastic band 476 is placed across portion 451 and portion 471 such that band 476 resides within grooves 454, 475 of portion 471 and grooves 453, 454 of portion 451. Therefore, in this normal position, latch 457 and mount 465 are physically connected by at least one elastic band 476 with tab 460 being received within and emanating from the slot 470. At least one band 476 applies a “positive biasing force” against planar portions 451 and 471 (e.g., this positive biasing force” comprises the elastic force caused by stretching the band 476), and therefore keeps mount 465 in physical contact with latch portion 457, thereby keeping tab 460 attached and wholly residing within slot 470, and thus keeps magnetic latch assembly 450 is a locked position, and this operation of band 476 is similar to the previously explained operation of assembly 10 as was described in FIGS. 1, 6, 7.

When an opening force (such as that by a hand of a user) is applied against drawer 490 in direction 510, in the absence of a magnetic key, such as magnetic key 200 of the preferred embodiment and as seen in FIG. 2, magnetic latch assembly 450 is restrained by cabinet edge 485 due to the engagement of edge 485 with abutment member 466, as was described previously in a preferred embodiment and as seen in FIG. 4. Further, the drawer 490 being moved in direction 510 causes hole 472 to move is direction 510 also by the movement of the mount 465 and causes elongated portion 462 of tab 460 to reside within and be restrained within elongated hole 472. Width 464 of circular end 461 being larger than width 473 of elongated hole 472 ensures that knob tab 460 does not disengage from hole 472 and causes tab 460 to continue to reside in slot 470, thereby preventing latch 451 from rotating along an arc opposite to arc 480 and dislodging tab 460 from slot 470.

Yet further and as was previously described in the preferred embodiment and as was seen in FIG. 2, when magnetic latch 450 is in an “unlocked” condition, band 476 provides a cooperative and compressive “biasing” force on latch portion 451 of latch 457 against member 471 of mount 465. The term “unlocked” means a movement of the latch assembly 450 where tab 460 has been withdrawn from slot 470 by the movement of the tab 460 along an arc in a direction counter clockwise to direction 480. The compressive “biasing” force on latch portion 452 against member 471 causes latch member 457 to pivot counterclockwise along arc 480 back into physical contact with mount 465 (i.e., by causing portion 458 to move in a direction of arc 480) and sliding portion 461 into hole 474, thereby returning tab 460 back into slot 470 and into a locking and latching condition (see FIG. 12).

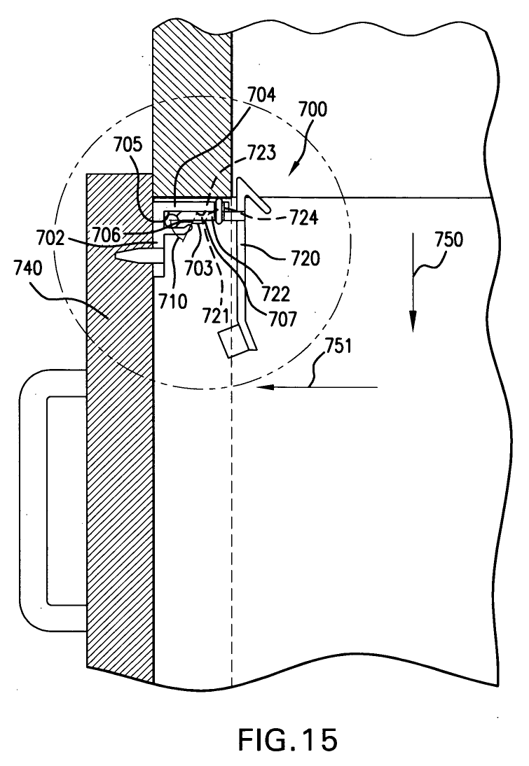

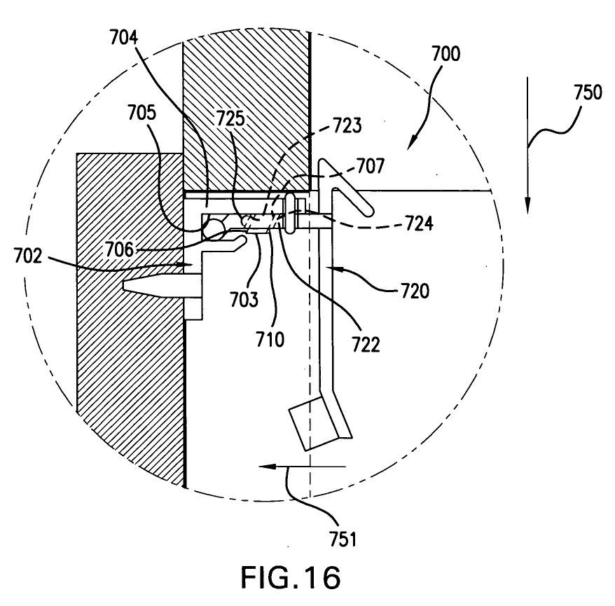

Further, in another non-limiting embodiment and best shown in FIGS. 15 and 16, mount 702 is adapted to carry a tab 703 while latch member 720 is adapted to include slot 721, while all other features of latch assembly 700 remaining the same (i.e., the tab 703 and slot 721 are switched to reside on the mount 702 and the latch member 720 respectively).

Particularly, mount 702 has a tab 703 which is formed on second planar member 704 and which extends from surface 705 of planar member 704 along direction 750, and tab 703 is substantially the same as tab 46 of the preferred embodiment as was seen in FIGS. 1-7, and thereby includes tapered edges 706, 707 and each having substantially the same slope or taper 710. Moreover, Latch assembly 700 also comprises a latch member 720, which comprises a slot 721 formed on planar member 722, and slot 721 is substantially the same as slot 25 of the preferred embodiment as was seen in FIGS. 1-7, and includes tapered or beveled edges 723, 724 and each having substantially the same slope or taper 725. In a normal and “resting” condition, as shown in FIG. 15, latch member 720 is coupled to mount 702 so that tab 703 wholly resides within and is received by slot 721, as was seen in the preferred embodiment in FIGS. 1-6. The latch assembly 700 operates substantially the same as latch assembly 10 of the preferred embodiment seen in FIGS. 1-6, and prevents door 740 from being opened when an “opening” force is applied to door 740 in direction 751 by restraining tab 703 against slot 721. It should be appreciated that any of the previously described latch assemblies 10, 350, 400, 700 may have the tab 703 or slot 721 formed on either the mount, such as mount 702 or latch member 720.

Further, and as shown in FIG. 1, a cabinet 100 having a drawer, such as drawer 102, may be selectively latched or locked by providing a magnetic latch assembly 10 as described in the preferred embodiment, and physically attaching mount 20 to inside surface 103 of drawer 102, in one non-limiting embodiment, by screws although the use of glue, nails or any similar attachment means could be utilized. Magnetic latch assembly 10 may be selectively attached to inside surface 103 at any height on inside surface 103 as long as abutment member 42 extends in direction 2 which is orthogonal to surface 106. Next, the drawer 102 is closed by applying a force on drawer handle 101 until inside surface 103 makes contact with drawer edge 108, and the magnetic latch assembly 10 now is in a latched and locked position.

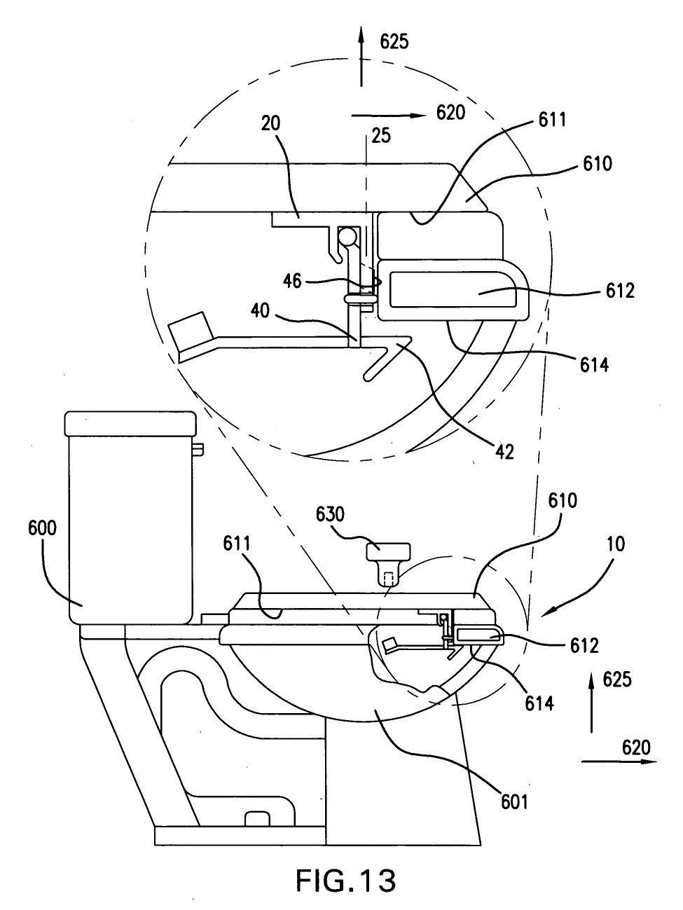

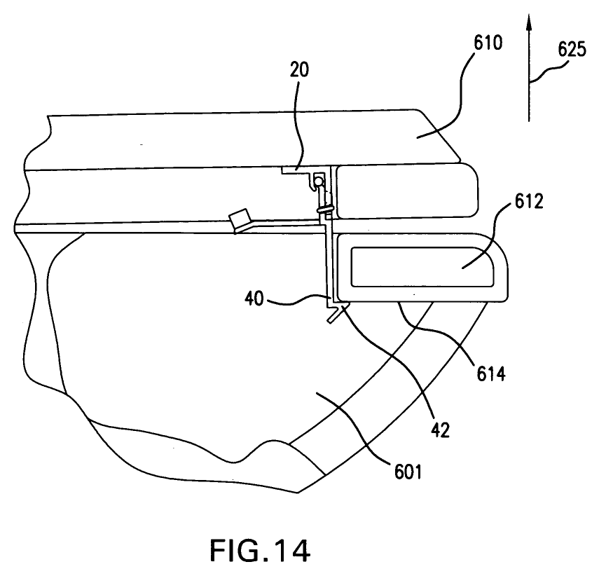

Yet further in another non-limiting embodiment such as that depicted in FIGS. 13-14, a toilet, such as toilet 600, may be easily and securely latched or locked by a magnetic latch assembly, such as magnetic latch assembly 10, although any of the previously described magnetic latch embodiments may be utilized for preventing infants and small children from opening a toilet bowl 601 and injuring themselves.

Particularly, an assembled magnetic latch assembly 10, as one non-limiting example of a magnetic latch assembly as was described in the preferred embodiment, is attached (e.g. by screws, glue) to toilet 600 by coupling mount 20 of assembled magnetic latch assembly 10 to inside surface 611 of toilet lid 610 so that abutment member 42 of latch member 40 extends beyond surface 614 of inside edge 612 (i.e., in a direction opposite direction 625) of toilet bowl 601. It should be appreciated that latch assembly 10 may be adapted to provide for a variety of toilets by providing a latch member 40 that may be formed of varying lengths so that abutment member 42 may engage an inside edge and selectively latch a toilet.

In operation, abutment member 42 engages surface 614 of inside edge 612 when an opening force is applied on toilet lid 610 in direction 625 and in the absence of a magnetic key 630 applied in the vicinity of latch assembly 10, and causes tab 46 of latch member to engage and be restrained from moving in the 625 by slot 25 of mount 20, and as was described in the preferred embodiment. Abutment 42 being engaged by edge 612 prevents toiled lid 610 from further travel in direction 620 and prevents toilet lid 610 from being travel in direction 620 as well, therefore effectively and selectively latching toilet 600 and thereby preventing infants and small children from opening toilet lid 610 without a magnetic key and falling into toilet bowl 601 and injuring themselves.

It is to be understood that the inventions are not limited to the exact embodiments which has been described above, but that various changes and modifications may be made without departing from the spirit and the scope of the inventions as they are more fully delineated in the subjoined claims. Thus, it should be appreciated that the foregoing inventions, in part, provide a magnetic latch assembly, which allows a cabinet to be selectively latched without user intervention on any portion that combines to form the magnetic latch assembly. The “normal state” of the foregoing magnetic latch assembly is “latched” or locked. It should further be appreciated that the foregoing described magnetic latch assemblies, such as latch assembly 10, may be adapted to selectively latch (i.e. put in a locked condition) a wide variety of articles of furniture that comprise a drawer. It should be further appreciated that magnetic latch assembly 10 may be placed at substantially any convenient location upon the drawer 102 and that, in the most preferred although non-limiting embodiment, the magnetic latch assembly includes band 33.

What is claimed is:

1) A magnetic latch assembly comprising
a mount which includes a slot and which is selectively attached to a movable door, wherein said door is selectively movable from a first closed position to a second open position;
a first portion which includes a biasing portion which physically couples said first portion to said mount and which forcibly causes said first portion to normally reside within said slot, effective to cause said door to be prevented from moving from said first closed position to said second open position, wherein said first portion further includes a magnet; and
a handheld magnetic key which, when selectively brought in close proximity to said magnet, causes said first portion to be forcibly removed from said slot, effective to allow said door to be selectively moved from said first closed position to said second open position.

2) The magnetic latch assembly of claim 1 wherein said handheld magnetic key applies an attractive magnetic force on said magnet.

3) The magnetic latch assembly of claim 2 further comprising a strike.

4) The magnetic latch assembly of claim 3, wherein said biasing portion comprises a band and a tab.

5) The magnetic latch assembly of claim 3, wherein said biasing portion comprises a spring and a tab.

6) The magnetic latch assembly of claim 3, wherein said biasing portion comprises a tab and a third and a fourth magnet.

7) A magnetic latch assembly comprising:
a first “L-shaped” bottom member having a first planar portion with a cavity, and a second planar portion which orthogonally projects from said first planar portion, and wherein said second planar portion includes a raised stop which wholly lies in a plane which is parallel to said second planar portion and wherein said first and second planar portions form an interior reception space in which said stop portion resides; and
a top member having a second “L-shaped” member comprising a third planar portion, said third planar portion includes a tab on a surface of said third planar portion that wholly resides within said slot of said first planar portion, and wherein said third planar portion is substantially similar to said first planar portion and which selectively abuts said first planar portion;
and wherein said top member further having a fourth planar portion which is substantially similar to said second planar portion, which orthogonally projects from said third planar portion and which wholly resides in a plane which is parallel to said plane containing said abutment member;
and wherein said top member further having a third member having a fifth planar portion which is coupled to said fourth planar portion and a sixth portion which projects from said fifth planar portion to form an acute angle; and wherein said top member further comprising a fourth planar member which projects from said fourth planar portion, and which includes a first magnet;
a biasing portion for coupling said first “L-Shaped” bottom member with said top member; and a second magnet which is remote from said first magnet, and whereby said second provides an attractive force on said first magnet to pivot said second member to an unlatched condition when said second magnet is in the vicinity of said first magnet.

8) The magnetic latch assembly of claim 7 further comprising a strike.

9) The magnetic latch assembly of claim 8, wherein said biasing portion further comprises a band and a tab.

10) The magnetic latch assembly of claim 8, wherein said biasing portion comprises a spring and a tab.

11) The magnetic latch assembly of claim 8, wherein said biasing means comprises a tab and a third and a fourth magnet.

12) A method for selectively latching a cabinet comprising the steps of providing a cabinet with a door, wherein said door has an inside surface and an outside surface; fixedly securing a magnetic latch assembly upon said inside surface of said door of said cabinet; closing said door and causing said magnetic latch assembly to securely and selectively latch said cabinet.

13) A method for selectively latching a toilet comprising the steps of providing a toilet with a toilet lid, wherein said toilet lid has an inside surface and an outside surface; fixedly securing a magnetic latch assembly upon said inside surface of said toilet lid of said toilet; closing said toilet lid and causing said magnetic latch assembly to securely and selectively latch said toilet.
